(19) United States
(12) Patent Application Publication
(10) Pub. No.: US 2005/0267658 A1
(43) Pub. Date: Dec. 1, 2005

(54) Intelligent and efficient system and/or method for automatic notification and/or enforcement of legal traffic speed limits and spots

(76) Inventors: Yong Yuan, Fremont, CA (US); Xiang Chen, Fremont, CA (US)

Correspondence Address: YONG YUAN & XIANG CHEN, 3984 WASHINGTON BLVD. # 118, FREMONT, CA, 94538, US

(21) Appl. No.: 10/846,135

(22) Filed: May 13, 2004

(51) Int. Cl. G06F 7/00

(52) U.S. Cl. 701/36; 701/117

(57) ABSTRACT

The present invention provides an intelligent and efficient system (600) and/or method (600) for automatic notification and/or enforcement of legal traffic speed limits and stops, comprising roads, streets, highways, construction zones, accident sites, and anywhere needed (400) installed at appropriate advanced locations with information tags (101) written with information including the according speed limit and/or stop information and vehicles (500) installed or built-in with information readers (201) capable of wirelessly and automatically reading information from the information tags (101) while the vehicles (500) travel. The read and other on-the-road information is displayed on visual displays (302) inside vehicles (500) and/or is voiced via audio devices (303) inside vehicles (500) for automatically notifying the vehicle drivers. Furthermore the in-vehicle speed control systems (301) use the speed limits read in by the information readers (201) to automatically enforce vehicles (500) to travel only within the speed limits.

### FIELD OF THE INVENTION

The present invention relates to traffic law notification and/or enforcement system and/or method and more particularly to system and/or method that automatically notify vehicle drivers about traffic law or regulation information including legal or required traffic speed limits and/or stops on the roads, streets, highways, construction zones, accident sites, and anywhere as needed while vehicles travel and/or automatically enforces traveling vehicles within the legal or required speed limits of roads, streets, highways, construction zones, accident sites, and anywhere as needed, with minimum cost.

### BACKGROUND OF THE INVENTION

It has a high risk of having traffic accident to drive a vehicle without knowing the safe speed of a road.

A prior art has attempted to solve this problem by using posters or signs showing legal or “safe” traffic speed limits and/or stops for vehicles are installed along roads, streets, and highways in United States and in many other countries for notifying vehicle drivers and for enforcing legal traffic speed limits and stops for reducing the risk of having traffic accidents. But while driving many drivers miss the opportunities to see the signs or ignore the signs or could not find the signs or knowingly drive with certain speed higher than the legal speeds. Then accidents occur sometimes.

Another prior art has attempted to resolve the problem is to build bumpers on the road in local areas, which is expensive and inefficient and makes the road awkward. And it could cause human injury and/or property damages if motorists do speeding over bumpers.

A prior art has attempted to enforce legal speed limit by use of police forces armed with laser or radar speed detector to monitor vehicles' speeds. Once a motorist's illegal speeding is detected, a police person will chase the motorist, use the siren lights to signal the motorist for stopping the vehicle, and then issue a citation to the motorist. Yet the illegal speeding has already occurred. This method is expensive yet not efficient.

Another prior art has attempted to enforce speed limit by use of automatic system that consists of a laser or radar speed detector and cameras. Once a motorist speeds beyond the legal speed limit, cameras will take photos of the motorist and the vehicle with the plate number. And then citation will be mailed to the motorist or the vehicle owner's home. Still, this way is expensive and inefficient.

None of the above systems or methods provide any economic, efficient, or effective method for enforcing notifying or enforcing legal speed limits. And most vehicle drivers and motorists usually drive with speeds 5˜10 miles per hour higher than the known speed limits because in reality polices only intend to stop vehicles that travel with speeds more than 5˜10 miles per hour higher than the known speed limits for minimizing disputes. Thus legal speed limits are not restrictively enforced.

Each year more than 50,000 people in the United States and more than 200,000 people in the world die due to traffic accidents and more than 1 million people are injured and billions dollars are lost due to traffic accidents.

The fact is that illegal speeding is one of the leading factors that trigger traffic accidents. It is, therefore, desirable to provide an economic, efficient, and effective system or method for vehicles' legal speed limit enforcement and notification.

### SUMMARY OF THE INVENTION

It is an object of the present invention to provide an intelligent and efficient system and/or method that automatically notify and/or enforce legal or required traffic speed limits and/or stops with minimum cost. It is particular desirable to provide a system and/or method that automatically notify vehicle drivers or motorists with on-the-road speed limit and/or stop information through in-vehicle visual and/or audio devices and/or automatically enforce vehicles' legal speed limits through in-vehicle speed control systems. With the speed limit and/or stop notification system and/or method, vehicle drivers are notified automatically with the real-time or on-the-road speed limit and/or stop information so that vehicle drivers can easily follow legal speed limits without the necessity to look for posters or signs of speed limit or wondering what speed limits are where there is no poster of speed limit can be found. With the automatic speed limit enforcement system and/or method, vehicles are automatically enforced to travel within legal or required speed limits.

In one embodiment, disclosed is a system and/or method comprising roads, streets, highways, construction zones, accident sites, and anywhere as needed installed with information devices or tags written with speed limit and/or stop information at appropriate locations. These information tags are readable by information readers installed on/in the vehicle.

In another embodiment, disclosed is a system and/or method comprising vehicles installed or built-in with devices comprising:

a). Information reading devices or information readers capable of automatically and wirelessly reading speed limit and/or stop information from said tags while the vehicles travel;

b). Visual displays capable of converting said information read by said information reader from said information tags into human understandable texts, graphics, or video for automatically notifying vehicle drivers with information including speed limit and/stop information; and/or

c). Audio devices capable of converting said information read by said information reader from said information tags into human understandable voices for automatically notifying vehicle drivers with information including speed limit and/or stop information; and/or

d). Speed control systems capable of automatically enforcing vehicles' travel speed within legal or required speed limits or stop information provided by said information readers.

In both above embodiments, disclosed preferably comprise passive radio frequency identification tags, i.e., RFID tags, as the information tags and radio frequency identification readers, i.e., RFID readers, as the information readers.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figure(s), wherein:

FIG. 1 illustrates the architecture the system and/or method 600 for legal traffic speed limit and/or stop notification and/or enforcement of the present invention; comprising roads, streets, highways, construction zones, accident sites, anywhere as needed 400 installed with speed limit and/or stop information devices or tags l01 and vehicles installed or built-in information readers 201, information displays 302, audio devices 303, and speed control systems 301 of the invention.

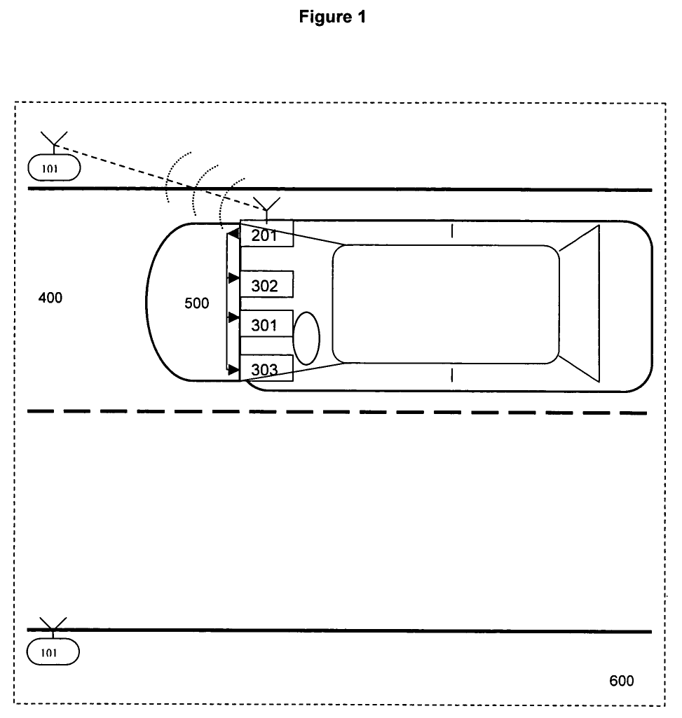

FIG. 2 illustrates border locations between the automatic notification and/or enforcement areas 601 and the non-automatic notification and/or enforcement areas 701 are installed with border information tags 102 containing information indicating current locations are the borders. Said information readers 201 read border information tags 102 wirelessly as well for providing the border information to said visual displays 302, said audio devices 303, and said vehicle speed controls systems 301 and for determining if vehicles 500 are entering or leaving the automatic notification and/or enforcement areas.

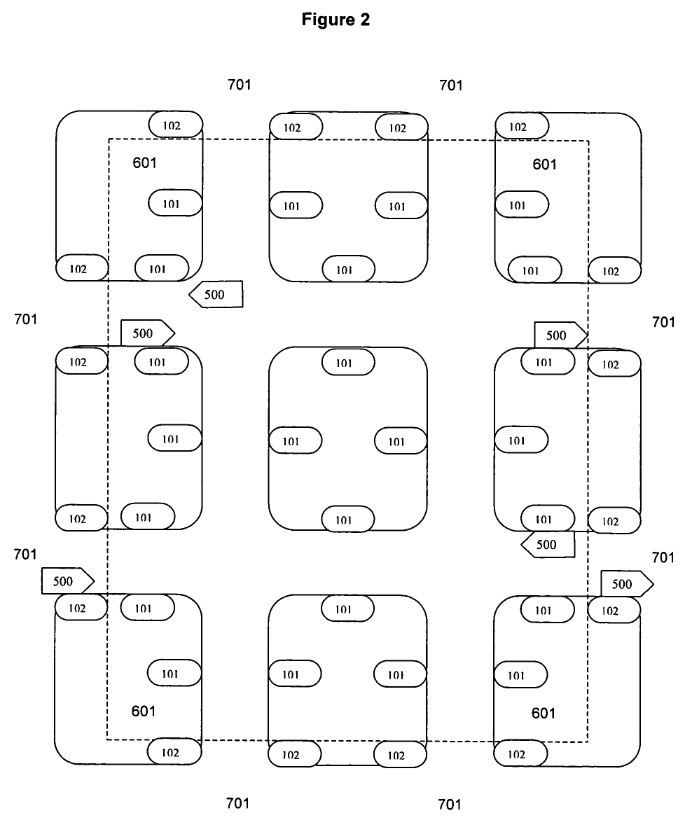

### DETAILED DESCRIPTION OF THE INVENTION

The present invention provides an intelligent and efficient system and/or method (600) for automatic legal traffic speed limit and/or stop notification and enforcement. The system and/or method 600 comprise roads, streets, highways, construction zones, accident sites, and anywhere as needed 400 installed information tags 101, preferably passive RFID tags or transponders 101, at appropriate locations of roads, written with the according vehicles' legal or required speed limit information and location information if desired, or having them so. The system and/or method 600 further comprise vehicles 500 installed or built-in with the information readers 201, preferably RFID readers 201, capable of automatically and wirelessly reading the information from information tags 101, or having them so. Each vehicle 500 has one information reader 201 installed or built-in. Furthermore the system and/or method 600 comprise vehicles installed or built-in with visual displays 302 capable of converting the information read by the information reader 201 from the information tags 101 into human understandable texts, graphics, or video for automatically notifying vehicle 500 drivers with information including speed limit and/or stop information; and/or audio devices 303 capable of converting the information read by the information readers 201 from the information tags 101 into human understandable voices for automatically notifying vehicle 500 drivers with information including speed limit and/or stop information; and/or speed control systems 301 capable of automatically enforcing vehicles' travel speed within legal or required speed limits provided by said information readers, or having them so.

Said information tags 101 could be of any type including electronic, optic, or/and magnetic type of any available at present or in future and could be either a read-only device or readable and write-able or rewritable device. Preferably such information tags 101 are inexpensive, reliable, and effective. As of today, preferably, either passive or active RFID (radio frequency identification) tags 101 are used due to their characteristics of low cost, high efficiency, and high reliability. Passive RFID tags 101 that do not need any power supply attached are readable wirelessly by RFID readers 201 from up to 15 feet away as of today and they cost only a few cents each in US currency. Soon they will cost only $0.01˜$0.05 each. Active RFID tags 101 are readable wirelessly by RFID readers 201 from up to 100 feet away as of today and they costs reasonably more. RFID tags 101 have advantages of ultra small sizes and portability, which is suitable for construction zones and accident sites as well. Relatively passive RFID tags are preferred for their low cost, portability, and relative short reading distance for minimizing crossroad information interferences.

At an appropriate location of a road or anywhere needed 400 for where legal vehicle speed limit must be indicated, preferably a RFID tag 101 with the according legal or required speed limit and/or stop information and, if desired, location information and etc., is installed. For increasing the reliability, redundant RFID tags 101 stored with the same information are installed at the same or nearby location. RFID tags 101 could be installed at either edge of a road lane or/and in a road 400. Usually passive RFID tags 101 are preferred for minimizing the implementation cost and crossroad information interference. Where necessary, active RFID tags 101, which need power supply attached, are used. The power supplies could be any types that include AC/DC power supply where available and accessible, solar panel charged batteries, and/or windmill charged batteries.

In/on a vehicle, preferably a RFID reader 201 is installed for automatically and wirelessly reading information from RFID tags 101 installed at specific locations of a road 400. As of today, a RFID reader 201 costs around $100 and soon a RFID will cost only $50 or less, which is much affordable compared with the cost of purchasing a vehicle and worthwhile for sake of increasing safety.

There is a plurality of options regarding when or how to execute a read function for an information reader preferably a RFID reader 201. One option is that the RFID reader 201 is set to read information of RFID tags 101 with a constant time interval or clock rate while traveling. This means the RFID reader 201 sends a reading signal out for reading information once every interval of a certain time programmed into the reader. Another option is that a sensor capable of detecting a passing vehicle is installed at or near a location where a RFID tag 101 is installed. Once a vehicle 500 is near the vehicle detector detects it and transmits a wireless signal to activate the reader 201 for reading the information from the RFID tag 101. Still another option is that the RFID reader 201 is activated for reading information from RFID tag 101 when the vehicle acceleration in the any direction of X, Y, and Z is beyond a pre-determined value. This option requires that 1/2/3-dimensional acceleration sensor(s) installed in the vehicle and its output to be connected the RFID reader 201 for reading activation. It is helpful to have a manual option to activate the reading function of a RFID reader 101 whenever the motorist wants to read the legal speed limit at a location of a road 400. Other options are also available.

Once an in-vehicle RFID reader 201 is activated for reading information, it sends a reading signal out and a nearby RFID tag 101 is waken up by this signal and then transmits the stored information to the RFID reader 201 in/on the vehicle 500 with the energy either from the radio wave send from the RFID reader 201 in case of a passive RFID 101 or from the power supply attached to the RFID tag in case of an active RFID 101.

Once the information is read, the RFID reader 201 sends the information read to the speed control system 301 to set the legal speed limit so that the vehicle speed is controlled within the legal speed limit and to an in-vehicle display 302 and/or an audio device 303 for advise the motorist with the information read.

All new vehicles 500 should have the legal traffic speed limit and/stop notification and enforcement system's embodiments built-in. Most existing vehicle should have the legal speed limit enforcement system's embodiments 301/302/303 installed. For those vehicles 400 that cannot have the legal speed limit enforcement system's embodiments 301 installed, the legal speed limit notification embodiment that has an in-vehicle display 302 and audio device 303 for notifying the motorist should be installed. And all roads 400 should have information tags 101 installed at appropriate locations with legal or required speed limit and/or stop information and, if desired, other information such as location information.

The vehicle speed control systems 301 include cruise control (CC) systems, adaptive cruise control (ACC) systems, modified versions of either, and other kind of vehicle speed control systems, capable of enforcing vehicle speeds within legal or required speed limits.

The information readers 201 comprise RESET functions and associated RESET buttons which reset said information readers automatically at the beginning of ignition or manually. This RESET is defined as to suspend the function of automatic speed limit notification and enforcement for a pre-determined time, for example, 3 seconds. After RESET if no information from information tags 101 are read, vehicles 500 operate in manual mode, in which vehicle drivers must look for speed limit signs by himself or herself and manually control vehicle speeds within legal or required speed limits, until the first time when traffic law information including speed limit information is read from an information tag 101.

Border locations between the automatic notification and/or enforcement areas 601 and the non-automatic notification and/or enforcement areas 701 require border information tags 102 installed containing information indicating current locations are the borders. Said information readers 201 read border information tags 102 wirelessly as well for providing the border information to said visual displays 302, said audio devices 303, and said vehicle speed controls systems 301 and for determining if vehicles 500 are entering or leaving the automatic notification and/or enforcement areas.

This invention provides the advantage to the world with a much more intelligent, efficient, safer, and inexpensive legal traffic speed limit and/or stop notification and enforcement system 600 and/or method 600, which will significantly reduce the risks of having traffic accidents so that each year it saves hundreds of thousands lives, avoids million injuries, reduces property damages, and saves tons of money and time spent in the legal, medical, and insurance system.

The above-described embodiments of the present invention are intended to be examples only. Alterations, modifications, and variations can be effected to the particular embodiments by those of skill in the art without departing from the scope of the invention, which is defined solely by the claims appended hereto.

1. Intelligent and efficient system and method for automatic notification and/or enforcement of legal traffic speed limits and stops, that automatically notify vehicles drivers or motorists with the legal speed limits along roads, around constructions zones, around accident sites and at anywhere as needed and/or automatically enforce vehicles' speed limits, comprising:
i). Roads, streets, highways, construction zones, accident sites, and anywhere as needed installed at appropriate advanced locations with information devices or information tags that are written with information including speed limit and/stop information, and location information as well if desired;
ii). Vehicles installed or built-in with devices comprising:
a). Information reading devices or information readers capable of wirelessly and/or automatically reading speed limit and stop information from said information tags while the vehicles travel;
b). Visual displays capable of converting said information read by said information readers from said information tags into human understandable texts, graphics, or video for automatically notifying vehicle drivers with information including speed limit information; and/or
c). Audio devices capable of converting said information read by said information readers from said information tags into human understandable voices for automatically notifying vehicle drivers with information including speed limit information; and/or
d). Speed control systems capable of automatically enforcing vehicles' travel speed within legal or required speed limits provided by said information readers.

2. The system and/or method of claim 1, wherein said roads, streets, highways, construction zones, accident sites, and anywhere as needed are installed at appropriate advanced locations with said information tags containing information including speed limit and/or stop information accordingly, and location information as well if desired.

3. The system and/or method of claim 1, wherein the system and/or method include means of determining the appropriate advanced locations of said roads, streets, highways, construction zones, accident sites, and anywhere as needed for installing said information tags with the lowest cost.

4. The system and/or method of claim 1, wherein said appropriate advanced locations of roads, streets, highways, construction zones, accident sites, and anywhere as needed for installing said information tags include locations anywhere in, on, near, above, or under said roads, highways, construction zones, accident sites, and anywhere as needed.

5. The system and/or method of claim 1, wherein the system and/or method include means for writing or pre-writing or re-writing information including speed limit information into said information tags.

6. The system and/or method of claim 1, wherein said information tags are written with speed limit information according to the pre-determined speed limit information of specific roads, streets, highways, construction zones, accident sites, and anywhere as needed or according to the real-time variable speed limits derived by means including a synthesis of data collected from sensing a list including conditions of road, traffic, and weather.

7. The system and/or method of claim 1, wherein the border locations between the automatic notification and/or enforcement areas and the non-automatic notification and/or enforcement areas are installed with information tags containing information indicating current locations are the borders.

8. The system and/or method of claim 1, wherein said information tags are selected from a list of devices including electronic, optic, laser, magnetic, electro-magnetic, sonic, ultrasonic, infrasonic, infrared, radio frequency (RF), radio frequency identification (RFID), global positioning system (GPS), or/and of any combination of any from this list.

9. The system and/or method of claim 1, wherein said information tags are either passive or active, i.e., either without power supplies or with power suppliers attached.

10. The information tags of claim 9, wherein said power supplies include direct current (DC) power supplies converted from active current (AC) power supplies, battery-based power supplies, solar panel/array supported rechargeable battery based power supplies, and wind generated electric energy supported rechargeable battery based power supplies.

11. The system and/or method of claim 1, wherein said information tags preferably include radio frequency identification (RFID) tags of types including read-only, read/write, or rewritable RFIDs and

12. The system and/or method of claim 1, wherein said information tags further preferably include passive RFIDs for sake of their low cost and relative short distance of being read for avoiding cross-road information interference.

13. The system and/or method of claim 1, wherein the system and/or method include means for wirelessly and/or automatically reading speed limit information from said information tags into said information readers.

14. The system and/or method of claim 1, wherein said information readers are selected from a list of devices including electric, optic, laser, magnetic, electro-magnetic, sonic, ultrasonic, infrasonic, infrared, radio frequency (RF), and radio frequency identification (RFID), global positioning system (GPS), or/and of any combination of any from this list, that read or receive information or data wirelessly and/or automatically from said information tags.

15. The system and/or method of claim 1 and 11, wherein said information readers preferably include radio frequency identification (RFID) readers or scanners since said information tags are preferably radio frequency identification (RFID) tags.

16. The system and/or method of claim 1, wherein the read execution of said information readers includes being activated automatically by an internal programmable clock with a pre-determined time interval or clock cycle for reading speed limit information from said information tags.

17. The system and/or method of claim 1, wherein the read execution of said information readers includes being activated automatically by external signals generated from where information tags are or are nearby.

18. The system and/or method of claim 17, wherein said external signals include being derived by means including sensors, located near or next to said speed limit and/or stop information tags, capable of detecting a vehicle is passing this location and transmit activation signals to said information readers for reading the information from information tags.

19. The system and/or method of claim 1, wherein the read execution of said information readers could be activated manually by vehicle drivers anytime.

20. The system and/or method of claim 1, wherein said information readers comprise RESET functions and associated RESET buttons which reset said information readers automatically at the beginning of ignition or manually.

21. The system and/or method of claim 1, wherein said information readers provide the read information or data into in/on vehicle devices including said displays that convert the read information and/or the differences between actual vehicle speeds and the legal or required speed limits into human understandable texts or/and graphics or/and video and display the information for notifying vehicle drivers or motorists.

22. The system and/or method of claim 1, wherein said information readers provide the read information or data and/or the differences between actual vehicle speeds and the legal or required speed limits into in/on-vehicle devices including said audio device that convert read information into voice in human languages and speak for notifying vehicle drivers or motorists.

23. The system and/or method of claim 1, wherein said information readers provide the read speed limit information or data into said speed control systems capable of automatically enforcing the vehicle's maximum speed as the speed limits read from said information tags.

24. The system and/or method of claim 1 and 21, wherein said in-vehicle speed control systems include cruise control (CC) systems, adaptive cruise control (ACC) systems, and/or modified versions of either, capable of enforcing vehicle speeds within legal or required speed limits.
